(19) United States
(12) Patent Application Publication
(10) Pub. No.: US 2026/0089687 A1
(43) Pub. Date: Mar. 26, 2026

(54) RADIO CHANNEL SELECTION IN WIRELESS COMMUNICATION NETWORKS

(71) Applicant: QUALCOMM Incorporated, San Diego, CA (US)

(72) Inventors: Deepak TRIPATHI, Chennai (IN); Balaji Srinivasan THIRUVENKATACHARI, Bengaluru (IN); Subodh THAPA, Bangalore (IN); Rohit GARG, Hindaun City (IN); Arvind KRISHNA, Bengaluru (IN)

(21) Appl. No.: 18/895,700

(22) Filed: Sep. 25, 2024

(51) Int. Cl. H04W 72/02; H04L 5/00; H04W 28/02; H04W 72/542

(52) U.S. Cl. CPC H04W 72/02; H04L 5/0057; H04L 5/006; H04W 28/0236; H04W 72/542

(57) ABSTRACT

This disclosure provides methods, components, devices and systems for providing enhanced radio channel selection using messages between wireless devices. Some aspects more specifically relate to collecting wireless channel measurement and channel state information (CSI) during a channel scan process at a wireless device. The wireless device provides the collected CSI to another wireless device connecting to the wireless network to aid in its channel selection and network connection process. In some additional aspects, a receiving wireless device receives messages which include CSI collected at another wireless device in the wireless network. The receiving wireless device uses the received CSI to reduce a channel selection time and improve channel selection decisions during a channel selection process at the receiving wireless device.

### TECHNICAL FIELD

This disclosure relates generally to wireless communication, and more specifically, to improving radio channel selection and wireless connection quality of communication links between network devices in wireless communication environments.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. In some aspects, the techniques described herein relate to an apparatus for wireless communication at a wireless device, including a processing system that includes processor circuitry and memory circuitry. The processing system configured to cause the wireless device to receive a message including channel state information (CSI) for at least one channel of a plurality of channels in a wireless network and, during a channel selection process at the wireless device, preempt a scan of the at least one channel associated with the CSI. The processing system may also be configured to cause the wireless device to select a connection channel for connecting to the wireless network using the CSI.

In some examples, the message indicates the CSI is collected at an autonomous CSI device in the wireless network, where the CSI includes scan quality information for a first channel of the plurality of channels, device utilization information of the first channel by the autonomous CSI device and overall utilization information for the first channel.

In some examples, the message indicates the CSI is collected at a central CSI device in the wireless network, where the CSI includes a master information report. In some examples, the master information report includes CSI for a first channel of the plurality of channels and CSI for at least one additional channel of the plurality of channels.

In some aspects, where the CSI is encoded in a vendor-specific information element (IE) in the message. In some examples, the channel selection process is initiated at the wireless device by at least one of an initial connection to the wireless network by the wireless device and a channel quality degradation on a connected channel.

In some examples, preempting the scan of the at least one channel associated with the CSI includes pausing, at the wireless device, channel scans in the channel selection process and identifying, from the CSI, a channel quality for the at least one channel. In some examples, selecting the connection channel includes selecting the at least one channel when the channel quality for the at least one channel meets channel requirements for the wireless device, where selecting the at least one channel ends the channel selection process.

In some aspects, selecting the connection channel further includes, when the channel quality for the at least one channel does not meet the channel requirements for the wireless device, excluding the at least one channel from the channel scans in the channel selection process, resuming the channel scans at the wireless device and selecting a scanned channel associated with a channel quality that meets the channel requirements for the wireless device.

In some examples, the processing system is further configured to cause the wireless device to establish a wireless connection on the connection channel using the CSI, where the wireless connection includes connection properties selected using the CSI. In some examples, the processing system is further configured to cause the wireless device to update the wireless connection on the selected connection channel using updated CSI for the selected connection channel received via an updated message.

Another innovative aspect of the subject matter described in this disclosure can be implemented in a wireless communication device. In some aspects, the techniques described herein relate to an apparatus for wireless communication at a wireless device, including a processing system that includes processor circuitry and memory circuitry. The processing system configured to cause the wireless device to collect channel state information (CSI) for at least one channel of a plurality of channels in a wireless network and transmit a message including the collected CSI for the at least one channel.

In some examples, the wireless device is an autonomous CSI device in the wireless network, where collecting the CSI further includes scanning a first channel of the plurality of channels to collect scan quality information, collecting device utilization information of the first channel by the wireless device and collecting overall utilization information of the first channel.

In some examples, transmitting the message includes broadcasting the message including the collected CSI over the wireless network or transmitting the message including the collected CSI to a central CSI device in the wireless network.

In some aspects, the processing system is further configured to cause the wireless device to operate as an autonomous CSI device or a central CSI device based on a CSI collection policy at the wireless device. In some examples, the CSI collection policy includes one or more of a predefined policy for the wireless device and a negotiated policy for the wireless device negotiated between the wireless device and one or more additional wireless devices in the wireless network.

In some examples, the wireless device is a central CSI device in the wireless network, where collecting the CSI further includes receiving CSI for a first channel of the plurality of channels from a first scan device, receiving CSI for at least one additional channel of the plurality of channels from at least one additional scan device and storing the CSI for the first channel and the CSI for the at least one additional channel as a master information report at the wireless device, where the collected CSI transmitted in the message includes the master information report.

In some examples, the wireless device transmits the collected CSI in a vendor-specific information element (IE) in the message.

In some examples, the processing system is further configured to cause the wireless device to collect updated CSI for the at least one channel of the plurality of channels in the wireless network and transmit an updated message including the updated CSI for the at least one channel.

Another innovative aspect of the subject matter described in this disclosure can be implemented in a method for wireless communication by a wireless communication device.

The method includes receiving a message including channel state information (CSI) for at least one channel of a plurality of channels in a wireless network and during a channel selection process at the wireless device, preempting a scan of the at least one channel associated with the CSI. The method may also include selecting a connection channel for connecting to the wireless network using the CSI.

Another innovative aspect of the subject matter described in this disclosure can be implemented in a method for wireless communication by a wireless communication device.

The method includes collecting channel state information (CSI) for at least one channel of a plurality of channels in a wireless network and transmitting a message including the collected CSI for the at least one channel.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a pictorial diagram of another example wireless communication network.

FIG. 4 shows a pictorial diagram of an example wireless communication environment.

FIG. 5 shows a pictorial diagram of an example CSI collection device in a wireless communication environment.

FIG. 6 shows a pictorial diagram of example central CSI collection device in a wireless communication environment.

FIG. 7 shows a system flow diagram illustrating an example process for collecting and using CSI to select a radio channel in a wireless communication environment.

FIG. 8 shows a flowchart illustrating an example process performable by a wireless device that supports selecting a connection channel using CSI in a wireless communication environment.

FIG. 9 shows a flowchart illustrating an example process performable by a wireless device that supports selecting a connection channel using CSI in a wireless communication environment.

FIG. 10 shows a flowchart illustrating an example process performable by a wireless device that supports collecting and providing CSI in a wireless communication environment.

FIG. 11 shows a flowchart illustrating an example process performable by a wireless device that supports collecting and providing CSI at central CSI devices and autonomous CSI devices in a wireless communication environment.

FIG. 12 shows a flowchart illustrating an example process performable by a wireless device that supports collecting and providing updated CSI in a wireless communication environment.

FIG. 13 shows a block diagram of an example wireless communication device that supports collecting and using CSI to select a radio channel in a wireless communication environment.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects relate generally to wireless communication and more particularly to providing enhanced radio channel selection and improved quality of network connections using messages between wireless devices. In some examples, the wireless devices may include devices that rely on low latency network connections such as extended reality (XR) devices, wireless earbuds, and gaming devices that rely on persistent and uninterrupted network connections. Some aspects more specifically relate to collecting wireless channel measurement and state information (herein referred to as channel state information (CSI)) during a channel scan process at a wireless device in a wireless network. In some examples, one such wireless device provides the collected CSI to another wireless device connecting to the wireless network to aid in its channel selection and network connection, data communication process. In some examples, the wireless device may function as an autonomous CSI device and collect CSI for a limited number of channels, such as the home channel for that wireless device and other channels scanned by the wireless device. In some aspects, an autonomous CSI device broadcasts the collected CSI to various devices in the network using a vendor-specific information element (IE) in a message. In some examples, the wireless device may serve as a central CSI device by collecting CSI for multiple channels in a wireless network from several connected devices. For example, a wireless device in the wireless network may provide CSI collected at the wireless device to the central CSI device independently or as a response to request from the central CSI device. In some examples, the central CSI devices may also broadcast the CSI collected at the respective device encoded in a vendor specific IE in a message.

In some aspects, a receiving wireless device may receive messages include CSI from one or more autonomous CSI devices and central CSI devices and use the shared CSI to improve channel selection decisions at the receiving device. For example, the receiving wireless device may use the CSI provided in the received message to simplify or reduce processing overhead in its channel selection processes during both initial connection to a wireless network and channel switching in the wireless network. In some examples, the connecting wireless device preempts a scan of any channels associated with the received CSI by pausing channel scanning and using the received CSI to determine whether the associated channels are suitable for connecting the wireless device to the wireless network. In some examples, the CSI for a given channel includes scan results as well as channel utilization and other spectral information. In some examples, the wireless device uses the various information included in the CSI to determine whether the given channel meets its traffic quality of service and connectivity requirements. In some examples, when the signal quality and/or traffic latency profile of the channels associated with the CSI is sufficient for a connection to the wireless network, the wireless device connects using one of the channels associated with the received CSI. In some other examples, such as when the quality of the channel is not sufficient for a connection to the wireless network, the wireless device resumes scans of the wireless channels in the networks while skipping the one or more channels associated with the CSI. In some examples, the wireless device also establishes and updates a wireless connection on a connection channel using the CSI, including using the CSI to select connection properties. In some examples, the connection properties include network traffic shaping parameters to meet traffic latency requirements for the wireless connection.

Particular aspects of the subject matter described in this disclosure can be implemented to realize one or more of the following potential advantages. Enhanced CSI shared between devices in a wireless network provides improved network connections and decreases a time needed for channel selection, particularly in devices that rely on low latency connections. For example, XR devices rely on persistent and reliable network connections to provide a seamless user experience. By utilizing CSI collected and observed at various wireless devices in a wireless network and shared between the wireless devices, including XR devices, aspects of the present disclosure may decrease the time it takes for a wireless device to initially connect to a channel in a wireless network, reduce the frequency of channel changes during a network connection, and reduce the time required to change channels upon degradation of a connected channel.

More specifically, the use of previously collected CSI shared through messages allows for a wireless device to reduce or eliminate the number of channels it needs to scan while connecting to the wireless network. For example, an autonomous CSI device utilizes the information it collects during a channel scan and connection process to provide a neighboring device with CSI information via a message. In some examples, using a vendor-specific IE in a message to communicate CSI between devices provides an efficient and easily parsed method of communicating CSI between devices. Autonomous CSI devices allow for the wireless device to leverage the time it spends scanning channels and collecting CSI to increase the overall efficiency of low latency devices in the network. In some examples, central CSI devices provide for increased information sharing using CSI collected from several sources, such as additional wireless devices. This increased information allows for a receiving wireless device to use the additional CSI to further reduce latency and increase channel selection resilience. For example, the wireless device uses the information provided in the CSI to establish wireless connections with network traffic shaping parameters that meet traffic latency requirements for the wireless connection and avoid causing congestion or traffic collisions on the selected channel.

In some aspects, the receiving wireless device uses CSI received via messages to reduce time spent selecting a channel and conserving resources at the wireless device. For example, when the shared CSI received from other devices indicates that the wireless device can connect to a channel, the wireless device may preempt continued scanning and connect directly to that channel, reducing the time and resource usage needed to scan all available channels. In some examples, the shared CSI may indicate that none of the channels included in the CSI are suitable for connection, such that the wireless device may skip the scan of these unsuitable channels, which also reduces the time and resource usage needed to scan available channels for the connection to the wireless network. Such reductions in the resource usage and latency allow for more efficient and persistent channel selections at latency sensitive devices connected to the network.

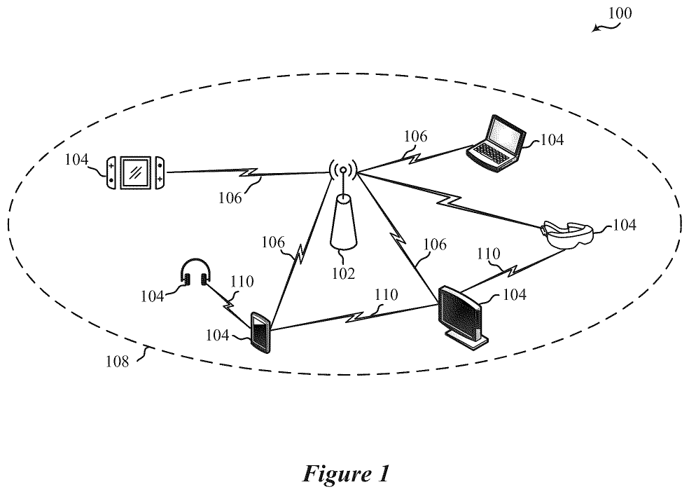

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6μs per OFDM symbol). The AP 102 or the STA 104 using 4096-QAM may enable a 20% increase in data rate compared to 1024-QAM given the same coding rate, thereby allowing users to obtain higher transmission efficiency.

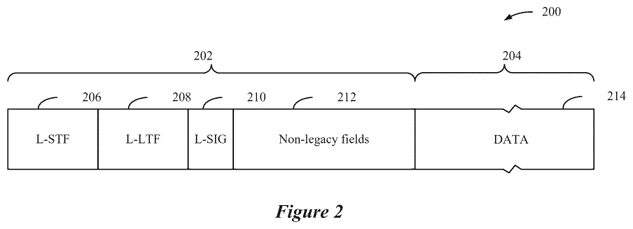

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the PHY preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (for example, packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

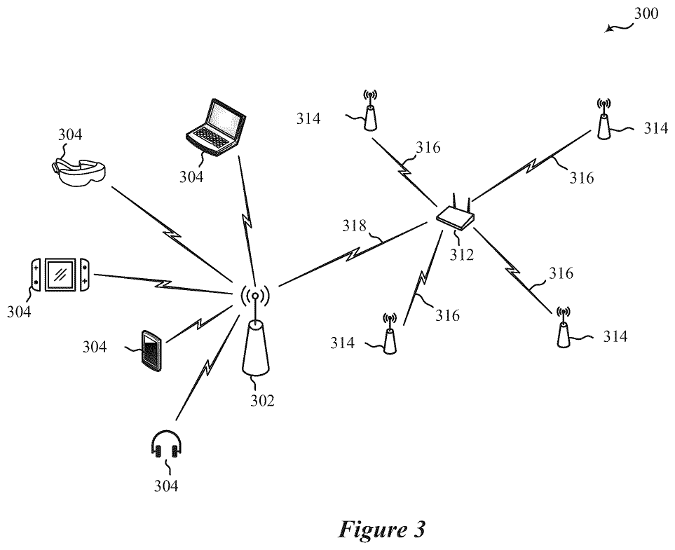

FIG. 3 shows a pictorial diagram of another example wireless communication network 300. According to some aspects, the wireless communication network 300 can be an example of a mesh network, an IoT network or a sensor network in accordance with one or more of the IEEE 802.11 family of wireless communication protocol standards (including the 802.11ah amendment). The wireless communication network 300 may include multiple wireless communication devices 314, which in some implementations may include APs 302, STAs 304, or both. The wireless communication devices 314 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 314 sense, measure, collect or otherwise obtain and process data and transmit such raw or processed data to an intermediate device 312 for subsequent processing or distribution. Additionally, or alternatively, the intermediate device 312 may transmit control information, digital content (for example, audio or video data), configuration information or other instructions to the wireless communication devices 314. The intermediate device 312 and the wireless communication devices 314 can communicate with one another via wireless communication links 316. In some examples, the wireless communication links 316 include Bluetooth links, or other PAN or short-range communication links.

In some examples, the intermediate device 312 also may be configured for wireless communication with other networks such as with a WLAN or a wireless (for example, cellular) wide area network (WWAN), which may, in turn, provide access to external networks including the Internet. For example, the intermediate device 312 may associate and communicate, over a Wi-Fi link 318, with an AP 302 of a wireless communication network 300, which also may serve various STAs 304. In some examples, the intermediate device 312 is an example of a network gateway, for example, an IoT gateway. In such a manner, the intermediate device 312 may serve as an edge network bridge providing a Wi-Fi core backhaul for the IoT network including the wireless communication devices 314. In some examples, the intermediate device 312 can analyze, preprocess and aggregate data received from the wireless communication devices 314 locally at the edge before transmitting it to other devices or external networks via the Wi-Fi link 318. The intermediate device 312 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

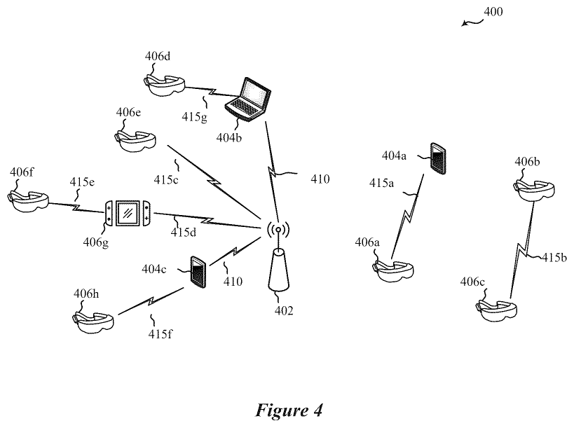

FIG. 4 shows a pictorial diagram of an example wireless communication environment 400. According to some aspects, the wireless communication environment 400 is an example of a WLAN or Wi-Fi network, such as the wireless communication network 100, a mesh network, an IoT network or a sensor network, such as the wireless communication network 300, or a combination of one or more instances of the wireless communication network 100 and the wireless communication network 300. Additionally, the various wireless devices in the wireless communication environment 400 may communicate using Bluetooth protocols, cellular protocols or other wireless communication protocols to communicate between the wireless devices present in the wireless communication environment 400. For ease of discussion, the wireless devices described in relation to FIG. 4-13 are generally described using Wi-Fi-based communication protocols; however, any of the wireless messages and wireless network connections and links described herein may use any combination of the wireless communication protocols described above.

In some examples, the wireless communication environment 400 includes wireless devices including wireless devices 404, wireless devices 406, and an AP 402. In some examples, the wireless devices 404 and the wireless devices 406 include various wireless communication devices such as any of the STAs 104 and the AP 102 described with reference to FIG. 1. Additionally, the wireless devices may also include any combination of APs 302, STAs 304, intermediate device 312 and wireless communication devices 314 described with reference to FIG. 3.

In some aspects, the wireless devices 404, the wireless devices 406, and the AP 402 are connected by communication links including wireless communication links 410 and wireless communication links 415a-415g (wireless communication links 415). The wireless communication links 410 and wireless communication links 415 may also be any combination of the communication links 106 and direct wireless communication links 110, described with reference to FIG. 1, or the wireless communication links 316 and Wi-Fi link 318, described with reference to FIG. 3.

The wireless communication environment 400 may include a large number of wireless communication devices, where the increasing number of devices may introduce various levels of interference, congestion and other wireless network connection limiting factors. These connection limiting factors, in turn, cause wireless devices in the wireless communication environment 400 to spend more time and resources attempting to establish clear network connections. As described herein, the wireless devices 404, 406, and AP 402 in the wireless communication environment 400 collect CSI throughout the wireless communication environment 400 and share the CSI with neighboring devices to reduce the time and resources needed to establish a network connection as well as improve the quality and persistence of established network connections.

In some examples, the wireless devices in the wireless communication environment 400 are latency sensitive devices that rely on network connections with minimal traffic delivery delays. For example, the wireless devices 406 may include extended reality (XR) devices. XR devices are wireless devices which provide augmented reality (AR), virtual reality (VR), mixed reality (MR) or any combination of AR, VR and MR realities via user interfaces. In some examples, XR devices provide a user experience to a user via virtual elements rendered to the user via user interfaces (UIs) including visual interfaces, such as displays, tactile or haptic interfaces and auditory interfaces. As the user interacts with the virtual elements in the XR device, the XR device may update and change the virtual elements, including providing updates or receiving updates from other XR or wireless devices. Any delay in in these updates may be perceived by the user and result in a degraded user experience.

In some aspects, XR devices provide the user experience by interacting with other wireless devices, including other XR devices, via wireless network connections such as wireless communication links 415a-415f. For example, head mounted display (HMD) devices or other wearable devices, such as smart glasses, provide a visual user experience to a user wearing the wireless device. In some examples, the wearable device may access and update virtual or augmented reality elements via communication with another wireless device. For example, a mobile phone, computer or game console, such as wireless device 404a, may provide virtual elements and virtual element updates for the user experience via the wireless communication link 415a. In order to prevent lag or delay in the user experience at the wireless device 406a, the wireless communication link 415a should be established quickly and provide a high bandwidth low latency connection between the wireless device 404a and the wireless device 406a. In some examples, XR devices may also communicate directly with another XR device or directly with a network device, such as directly connecting to an AP or other network gateway. For example, devices 406b and 406c directly communicate via link 415b and wireless device 406e directly communicates with a network device via connection 415c to the AP 402.

In some examples, each of the wireless communication links 415a - 415f rely on low latency high quality network connections in order to provide quality user experiences to the respective connected wireless devices. As described above, the QoS includes low latency connections such that large amounts of data can be transmitted between the wireless devices at quick speeds. Additionally, QoS for the XR devices often includes quick network connection and quick changes to the network connections. For example, if a communication link between an XR device and another wireless device begins to degrade resulting in delayed traffic delivery or increased congestion, the XR device may alter some aspects of its network connection, including a channel change to a radio channel with network properties that can provide a network connection at the QoS levels required by the XR device.

In some examples, the number of links or radio channels available to the wireless communication environment 400 is limited. For example, available Wi-Fi channels are subject to governmental regulations or other standards. In some examples, a large number of Wi-Fi devices in the wireless communication environment 400, along with other interference causing devices in the Wi-Fi channels may increase the need to verify that a given Wi-Fi or other radio channel is able to handle a network link or connection when established by a wireless device. For example, as the wireless device 406d begins initiating the wireless communication link 415g, the wireless device 406d may utilize a channel selection algorithm to select an optimal channel that allows for the QoS to be met for the wireless device 406a and as well as not cause increased interference to other devices in the wireless communication environment 400. In some examples, the selection of a channel with interference or high latency may result in a bad user experience at the wireless device 406d as well as increased interference for other devices, such as the wireless device 406e among others in the wireless communication environment 400.

In some examples, the various wireless devices in the wireless communication environment 400 utilize CSI collected at the individual devices to enhance or increase the amount of CSI available at neighboring devices while also conserving the resource and time expenditures at each individual device required to collect CSI. In some examples, the use of previously collected CSI shared through messages throughout the wireless communication environment 400 allows for a wireless device to reduce or eliminate the number of channels any individual device needs to scan while connecting to the wireless network or establishing a wireless connection. For example, as a device, such as the wireless device 406h, begins joining a network or otherwise establishing the wireless communication link 415f to the wireless device 404c, the wireless device 406h may utilize an enhanced channel selection process using CSI collected at neighboring devices, such as wireless device 406f, to determine the best radio channel on which to establish a connection.

For example, the wireless device 406f may use CSI received via messages from neighboring devices to reduce time spent selecting a channel and conserving resources at the wireless device. For example, when the shared CSI received from other devices indicates that the wireless device 406f can connect to a channel, the wireless device may preempt continued scanning and connect directly to that channel, reducing the time and resource usage needed to scan all available channels. Additionally, the wireless device 406f may establish a wireless connection on a selected channel with traffic shaping parameters derived from the shared CSI that avoids causing network traffic collision and congestion with the current network traffic on the channel. For example, the wireless device 406f may establish the wireless connection with network traffic shaping parameters to meet traffic latency requirements or QoS for an XR device as well as not cause increased interference to other devices in the wireless communication environment 400 or on the same selected channel.

In some examples, the shared CSI may indicate that none of the channels included in the CSI are suitable for connection, such that the wireless device 406f may skip the scan of these unsuitable channels, which also reduces the time and resource usage needed to scan available channels for the connection to the wireless network. Such reductions in the resource usage and latency allow for more efficient and persistent channel selections at latency sensitive devices connected to the wireless communication environment.

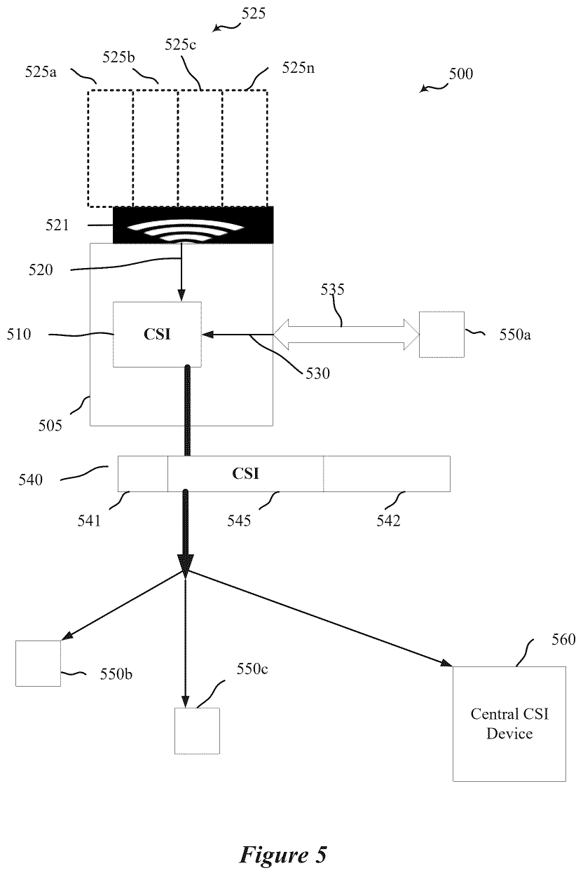

In some examples, in order to provide CSI through the wireless communication environment 400 each individual device including the wireless devices 404a-404c, AP 402 and devices 406a-406h may collect CSI for one or more radio channels and provide or broadcast the CSI to each of the other wireless devices in the wireless communication environment 400 or to a central collection device as described herein with reference to FIG. 5-7.

FIG. 5 shows a pictorial diagram of an example CSI collection device in a wireless communication environment 500. As described herein with reference to FIG. 4, enhanced CSI shared between devices in a wireless network provides improved network connections and decreases a time needed for channel selection, particularly in devices that rely on low latency connections. In order to provide the reduce connection time and improved network connections, the various wireless devices in a wireless communication environment collect CSI and transmit the locally collected CSI to other wireless devices in the environment. For example, the wireless communication environment 500 includes wireless device 505 which may include any of the wireless devices 404, 406 and AP 402 as described in reference to FIG. 4.

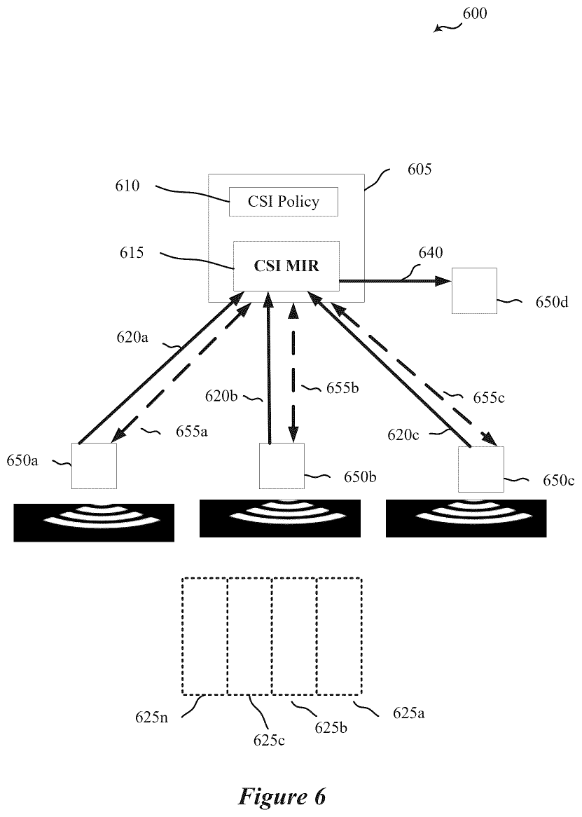

In some examples, the wireless device 505 is a CSI collection device and may operate as an autonomous CSI device or a central CSI device as described in more detail with reference to FIG. 6. In some examples, an autonomous CSI device utilizes the information it collects during a channel scan and network connection process to provide a neighboring wireless device with CSI information via a message. For example, the wireless device 505 collects CSI 510 for at least one channel of a plurality of channels, such as channels 525, in a wireless network. As depicted in FIG. 5, the wireless device 505 collects scan quality information 520 for radio channel 525a during a scan process 521 of the wireless communication environment 500. In some examples, the wireless device 505 may enter a Wi-Fi scan state to determine various channel qualities, such as interference congestion and other service qualities of the channels 525. In some examples, the wireless device 505 may scan more than one or may scan all of the channels 525 and include the scan quality information for each channel 525a-525n in the CSI 510.

In some examples, the wireless device 505 also collects utilization information 530 of the home or connection channel used by the wireless device 505. For example, upon completion of a scan of the channels 525, the wireless device 505 establishes a wireless or network connection, such as the connection 535, on the selected channel, such as the radio channel 525a. In some examples, the utilization information 530 includes device utilization information for the local or device specific utilization of the connection 535 and radio channel 525a. The wireless device 505 may also collect overall utilization information of the radio channel 525a, including network traffic associated with other network connections utilizing the radio channel 525a, incumbent systems on a given radio channel, other wireless devices on the radio channel 525a, and metadata related to CSI. This radio channel utilization information 530 is also added the collected scan information in the CSI 510. The utilization information in the CSI 510 provides a receiving device additional insight or detail into anticipated or future channel behavior. For example, scan quality information for the radio channel 525a may indicate that the radio channel 525a may handle additional network connections, but the utilization information 530 may indicate that additional network connections would result in degraded channel performance, such as increased latency in the network traffic. In some examples, the utilization information 530 information may be used by a receiving device to establish or update a wireless connection on the same channel to improve latency on the radio channel 525a by performing traffic shaping or other network traffic handling processes to avoid traffic collision and congestion on the channel.

In some examples, the collection and updating of the CSI 510 continues after an initial scan and connection establishment. For example, the wireless device 505 may continue updating the CSI 510 based on subsequent scan information for the channels 525 as well as updated connection information and utilization information for the connection 535. In some examples, the updated connection information and utilization information for the connection 535 may also be used by the receiving device in the traffic shaping or other network traffic handling processes to avoid traffic collision and congestion on the channel.

In some aspects, to provide the locally collected CSI 510 to other wireless devices, the wireless device 505 transmits a frame or message 540 which includes the collected CSI 510 for at least one channel. For example, the message 540 includes the CSI 510 for at least the radio channel 525a. In some examples, the scan quality information 520, the collection of utilization information 530, and the similar information for additional channels, such as channels 525b and 525c, may also be included in the CSI 510 collected by the wireless device 505 and transmitted in the message 540.

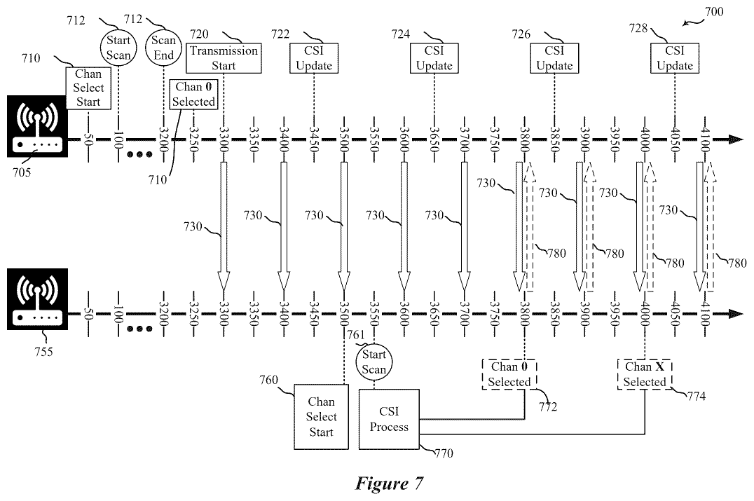

In some examples, the wireless device 505 provides the message 540 including the collected CSI 510 over a wireless medium and throughout the wireless communication environment 500 such that wireless devices, including wireless devices 550a, 550b and 550c receive the message 540. In some examples, the message 540 is a PDU, such as PDU 200 described with reference to FIG. 2 or other transmissible data structure. For example, the message 540 may include response communication or other similar frame/message in a probe request/response exchange. In some examples, the message 540 may also be a unicast communication, including a unicast response in a request/response exchange. In some examples, the message 540 is a Wi-Fi beacon and may include standard fields 541 and 542 as well as a vendor-specific information element (IE) 545. In some examples, the vendor-specific IE 545 is used to communicate CSI between devices and provides an efficient and easily parsed method of communicating CSI between devices. For example, the CSI 510 is included in the IE 545 and is parsable by the wireless devices 550a-550c, where the wireless devices 550a-550c may use the CSI 510 to select a radio channel for a network connection as described with reference to FIG. 7.

In some examples, the wireless device 505 also collects updated CSI for any combination of the channels 525 and transmits an updated frame or message including the updated CSI for the radio channels, as described in more detail in relation to FIG. 7. As described above, autonomous CSI devices allow for the wireless device to leverage the time it spends scanning channels and collecting CSI to increase the overall efficiency of low latency devices in the wireless communication environment 500. In some examples, the wireless device 505 may also transmit or broadcast the message 540 including the collected CSI 510 to a central CSI device 560 in the wireless network or wireless communication environment 500 as described in more detail with reference to FIG. 6.

FIG. 6 shows a pictorial diagram of example central CSI collection device in a wireless communication environment 600. In some examples, central CSI devices provide for increased information sharing using CSI collected from several sources in a wireless communication environment. This increased information allows for a receiving wireless device to use the enhanced CSI to further reduce connection times and increase channel selection resilience. In some examples, the wireless communication environment 600 includes wireless device 605 which may include any of the wireless devices 404, 406 and AP 402 as described in reference to FIG. 4 and device 505 as described with reference to FIG. 5 For example, while the wireless device 605 may serve as both a CSI collection device and may operate as a central CSI device. For example, the wireless device 605 may collect CSI 510 locally at the wireless device as described with reference to FIG. 5 as well as collect additional CSI from other devices as described in further detail herein.

In some examples, the wireless device 605 may select to operate as an autonomous CSI device or a central CSI device based on a CSI collection policy 610 at the wireless device 605. For example, the CSI collection policy 610 may be a predefined policy for the wireless device 605 or the wireless communication environment 600. Additionally, the policy 610 may also include a negotiated policy for the wireless device 605. For example, the wireless device 605 and devices 650a-650c may negotiate via communications 655a-655c between the wireless device 605 and the wireless devices 650a-650d. Through the communications 655a-655c the various devices may designate or assign one or more of the wireless devices as central CSI devices. As depicted in FIG. 6, the wireless device 605 is a central CSI device.

In some examples, the wireless device 605 receives CSI for a variety of radio channels, where the CSI is collected at other wireless devices. For example, the wireless device 605 receives CSI 620a for a first channel, such as channel 625a, from a first scan or collection device, such as the wireless device 650a. The wireless device 605 also receives CSI for at least one additional channel from at least one additional scan device. For example, the wireless device 605 receives CSI 620b and 620c for channels 625b and 625c wireless devices 650b and 650c.

In some aspects, the wireless device 605 stores the CSI for the first channel and the at least one additional channel as a CSI master information report (MIR) at the wireless device. For example, the wireless device 605 stores CSI 620a, 620b and 620c, as a CSI MIR 615 at the wireless device. In some examples, the wireless device 605 transmits or broadcasts a message 640 throughout the wireless communication environment 600, with the CSI MIR 615. In some examples, the CSI MIR 615 is transmitted in a frame or message similar to the message 540 described with reference to FIG. 5 and may be formatted in a vendor IE similar to IE 545. In some examples, a receiving device 650d receives the CSI MIR and parses the information, including CSI, to aid in selection a radio channel to establish a network connection as described in more detail in relation to FIG. 7-13.

FIG. 7 shows a system flow diagram illustrating an example process 700 for collecting and using CSI to select a radio channel in a wireless communication environment. As described herein, enhanced CSI shared between devices in a wireless network provides improved network connections between devices in a network or wireless communication environment and decreases a time needed for channel selection, particularly in devices that rely on low latency connections. For example, CSI collected at a device 705 and shared with a device 755 reduces the time needed for the wireless device 755 to establish a network connection as well as increases the quality and persistence of the established connection.

In some aspects, wireless devices 705 and 755 are wireless devices similar to wireless devices 505 and 605 as described in with reference to FIGS. 5 and 6. For example, the wireless device 705 may collect CSI and provide the CSI to the wireless device 755 which uses the received CSI in a channel selection process. In the example, shown in FIG. 7, the wireless device 705 is an autonomous device such as the wireless device 505 described here with reference to FIG. 5. Additionally, the wireless device 705 may also serve as a central CSI device similar to wireless device 605 described herein with reference to FIG. 6, where the CSI information exchange processes described herein includes CSI collected from other devices, such as the CSI MIR 615.

In some examples, process 700 begins at time 50 where the wireless device 705 initiates a channel selection process 710 to select a radio channel for a wireless connection. The channel selection process 710 may be a standard selection for a wireless network which does not utilize CSI provided from another device. In some examples, at time 100, the wireless device 705, as part of the channel selection process 710, begins a channel scan procedure 712 which scans radio channels at the wireless device 705. In some examples, this scan procedure is similar to the scan process 521 described with reference to FIG. 5. In some examples, the channel scan procedure 712 may scan each available channel or frequency in a wireless medium. For example, the channel scan procedure 712 may proceed through every available Wi-Fi channel to collect scan quality information for the various channels. In some examples, the scan process ends at time 3250. In some examples, the time requirement, such as from time 100 to time 3200, as well as the resource usage by the wireless device 705 to perform the channel scan procedure 712 may be reduced by the usage of CSI as described herein. At time 3250, the channel selection process 710 completes and selects a radio channel, such as Channel 0, as a home or connection channel for a network connection for the wireless device 705. As the wireless device 705 completes its channel selection process, it begins CSI transmission process 720 at time 3300. In some examples, the CSI transmission process 720 includes collecting device utilization information such as local or device specific utilization information of for the Channel 0 and overall utilization information of the Channel 0. The CSI transmission process 720 also includes transmitting a message 730, which includes the CSI collected at the wireless device 705 for at least the Channel 0. In some examples, the process 700 continues at the wireless device 705 with CSI updates 722, 724, 726, 728 at times 3450, 3650, 3850, and 4050, respectively. In some examples, the CSI updates include updating the CSI at the wireless device 705 for Channel 0, including updating one or more of the scan quality information, the local or device utilization information, and the overall utilization information for Channel 0. The CSI updates 722-728 also include transmitting the message 730 with the various updated CSI information.

In some aspects the process 700 continues at the wireless device 755. At times 50-3500 shown in FIG. 7, the wireless device 755 may be in a non-connected state such as powered off, booting up, or establishing a network connection. In another example, during the times 50-3500 the wireless device 755 may have an established network connection that begins to degrade or otherwise need a channel change. In some examples, at time 3500, the wireless device 755 begins a channel selection process 760 with a CSI selection process 770. In some examples, the channel selection process 760 with the CSI selection process 770 utilize CSI received from the wireless device 755 to decrease a time needed for channel selection and select an optimal channel for establishing a network connection. In some examples, the wireless device 755 receives the message 730, including CSI or update CSI, at times 3300, 3400, and 3500 parses the message 730 to extract the CSI received from the wireless device 705.

In some examples, at time 3500 the wireless device 755 begins a scan process 761 but preempts the scan process 761 to utilize the CSI received in the messages 730 in CSI selection process 770. In some examples, the CSI selection process 770 includes pausing all channel scans in the channel selection process 760. In some examples, the wireless device 755 determines, from the CSI, a channel quality for the Channel 0. In an example where the CSI provided by the wireless device 705 indicates that the Channel 0 is able to host a connection from the wireless device 755, the wireless device 755 selects Channel 0 in the connection establishment process 772 at time 3800. In some examples, the selection of Channel 0 allows for the wireless device 755 to establish a network connection without scanning any channels and with added insight into the resilience of the channel to host the network connection for the wireless device 755.

The selection and establishment of the network connection on the Channel 0 at the connection establishment process process 772 ends the channel selection process 760. In some examples, the wireless device 755 may establish a wireless connection on the selected Channel 0. In some examples, the wireless device may establish the wireless connection on the Channel 0 with connection properties selected using the CSI in the message 730. For example, the wireless device may establish the wireless connection with network traffic shaping parameters to meet traffic latency requirements for the wireless connection from the wireless device 755. In some examples, the wireless device 755 may use utilization information provided in the CSI to delay network traffic packet transmissions on the wireless connection or schedule network traffic at times to avoid congestion on Channel 0.

In another example, when the channel quality for Channel 0 does not meet the channel requirements for the wireless device 755. The process 770 includes determining, from the CSI, a channel quality for any additional channels included in the CSI. For example, if the message 730 includes additional CSI for other channels, the wireless device 705 also checks the channel quality to determine whether the wireless device 755 may establish a network connection on those channels. In some examples, the wireless device 755 may then utilize another channel represented in the CSI and proceed to the process 772 selecting the other channel. In another example, when no channel represent in the CSI is able to host a network connection for the wireless device 755, the process 770 includes excluding Channel 0 (and other channels) from the channel scans in the scan process 761 and resumes the channel scans. At time 4000, the wireless device 755 selects a scanned channel, Channel X that has a channel quality that meets the channel requirements for the wireless device 755 in the connection establishment process 774.

In some examples, the wireless device 755 may establish a wireless connection on the selected Channel X. In some examples, the wireless device may establish the wireless connection on the Channel X with connection properties selected using the CSI or updated CSI in the message 730. For example, the wireless device may establish or update the wireless connection with network traffic shaping parameters to meet traffic latency requirements for the wireless connection from the wireless device 755. For example, the wireless device 755 may receive CSI related to the Channel X in an update of the CSI in the messages 730. In some examples, the wireless device 755 may use utilization information provided in the CSI to delay network traffic packet transmissions on the wireless connection or schedule network traffic at times to avoid congestion on Channel 0. In some examples, the wireless device 755 may also begin a CSI transmission process, similar to the CSI transmission processes 720-728 and transmit a message 780 including the CSI collected at the wireless device 755 for the home or connected channel, such as Channel 0 or Channel X.

As depicted in FIG. 7, the process 760 at the wireless device 755 with the utilization of the CSI provided to the wireless device 755, is a shorter process than the channel selection process 710 at the wireless device 705. Additionally, the use of the additional utilization and other channel information provided in the CSI provides for the wireless device 755 to select a channel in the CSI when the channel will provide the required network connection over a longer period of time, reducing or preventing the need to changed channels or update a network connection during operation.

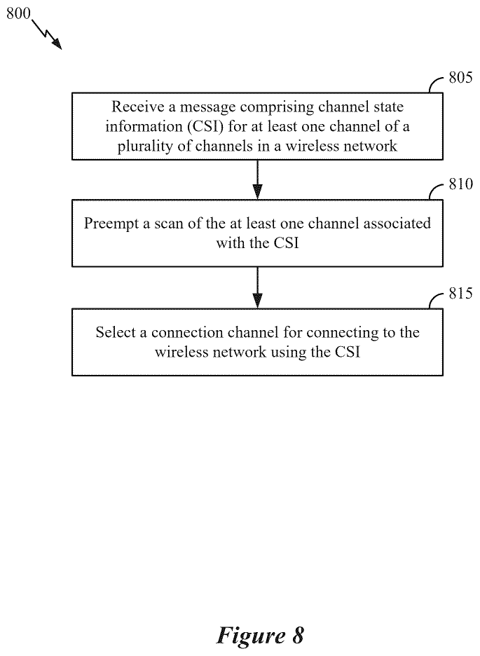

FIG. 8 shows a flowchart illustrating an example process 800 performable by a wireless device that supports selecting a connection channel using CSI. The operations of the process 800 may be implemented by a wireless device or its components as described herein.

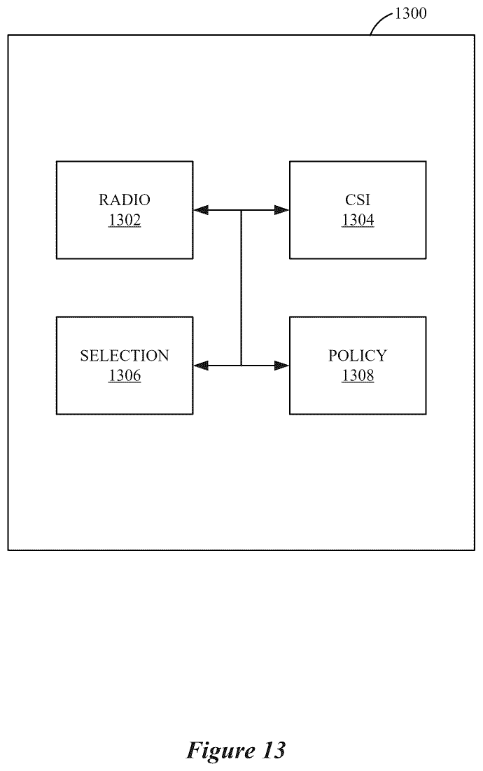

For example, the process 800 may be performed by a wireless communication device, such as the wireless communication device 1300 described with reference to FIG. 13, operating as or within a wireless device. In some examples, the process 800 may be performed by a wireless device such as one of the wireless devices 404, wireless devices 406 and an AP 402 described with reference to FIG. 4. Additionally, in some examples, the process 800 may be performed by the wireless device 755 described with reference to FIG. 7. In some examples, the process 800 uses enhanced CSI shared between devices in a wireless network or wireless communication environment to improve network connection quality and decrease the time needed for channel selection for the network connection.

In some examples, in block 805, the wireless device receives a message from a sending device in a wireless communication environment. For example, the wireless device may receive the message 540, the message 640, the message 730 or a combination of these frames, messages and communications. In some examples, the message includes CSI for at least one channel of a plurality of channels in a wireless communication environment. For example, with reference to FIG. 5, the wireless device 550b receives the message 540 which may include CSI 510 collected at the wireless device 505. The wireless device may also, with reference to FIG. 6, receive a message such as the message 640 which includes CSI MIR 615 for multiple radio channels. In some examples, the message includes CSI collected at the sending device and is encoded in a vendor-specific information element (IE) in the message. In some examples, using the vendor-specific IE in the message provides an easily parsed method of communicating CSI between devices. For example, the wireless device may use the vendor specified fields to determine the network properties for a radio channel from the parsed IE.

In some examples, the CSI includes information not immediately available to the wireless device through a standard spectrum or wireless medium scanning process. For example, the CSI may include, in addition to scan quality information, utilization information for devices and systems already established on the radio channel. For example, the sending device may include network utilization for the sending device and other devices on the channel in order to provide more detail to the wireless device on the availability of the channel for an additional network connection. In some examples, the wireless device uses the CSI at block 805 to reduce time spent selection a channel and conserving resources at the wireless device.

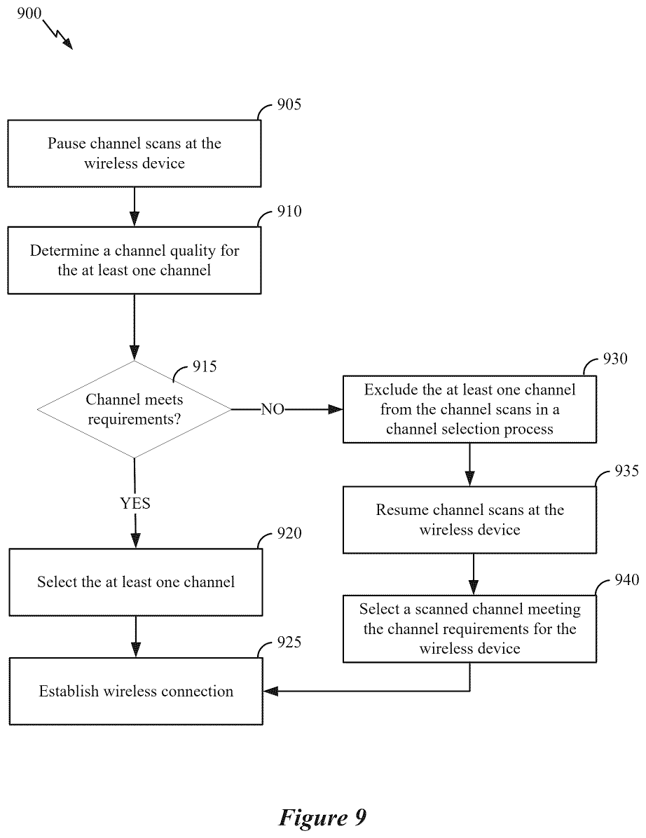

In some examples, in block 810, the wireless device preempts a scan of the at least one channel associated with the CSI. In some examples, the wireless device may preempt a scan during or as part of channel selection process at the wireless device. For example, as discussed in relation to FIG. 7, the wireless device 755 may initiate the channel selection process 760 including scan process 761 which is preempted by the wireless device in order to utilize the available CSI to select a channel. The scanning and channel selection process is described in more detail herein with reference to FIG. 9.

In some examples, in block 815, the wireless device selects a connection channel for connecting to the wireless communication environment using the CSI. In some examples, the wireless device uses CSI received to reduce time spent selecting a channel and conserving resources at the wireless device. For example, when the shared CSI received from other devices indicates that the wireless device can connect to a channel, the wireless device may preempt continued scanning and connect directly to that channel, reducing the time and resource usage needed to scan all available channels. Additionally, when the shared CSI indicates that a channel is not appropriate for a network connection, the wireless device may skip a scan of the channel and proceed with a channel selection process as described in more detail with reference to FIG. 9.

FIG. 9 shows a flowchart illustrating an example process 900 performable by a wireless device that supports selecting a connection channel using CSI. The operations of the process 900 may be implemented by a wireless device or its components as described herein. For example, the process 900 may be performed by a wireless communication device, such as the wireless communication device 1300 described with reference to FIG. 13, operating as or within a wireless device. In some examples, the process 900 may be performed by a wireless device such as one of the wireless devices 404, wireless devices 406 and an AP 402 described with reference to FIG. 4, wireless devices 505 and 605 described with reference to FIGS. 5 and 6 and device 755 described in relation to FIG. 7.

In some examples, in block 905, the wireless device, as part of a preempting the scan described in block 810 of FIG. 8, pauses all channel scans in the channel selection process at the wireless device. In some examples, the pause of the channel scans reduces the time and resource requirement needed at the wireless device to establish a network connection.

In some examples, in block 910, the wireless device determines, from the CSI, a channel quality for the at least one channel. In some examples, the wireless device parses the CSI information from the received message or beacon and determines scan quality information as well as channel utilization. In some examples, scan quality information in the CSI may indicate that a radio channel meets the needs for the network connection at the wireless device, but utilization information may indicate that the network connection may experience interference or congestion on or in the future. In this example, the wireless device may not establish the network connection on the channel and continue evaluating other channels in the CSI information or continue scanning the wireless communication environment.

In some examples, in block 915, the wireless device determines, from the channel quality for the at least one channel, whether a given channel meets QoS requirements for the wireless device. In some examples, such as when the CSI indicates that the associated channel meets the requirements, process 900 proceeds to block 920 where the wireless device selects the at least one channel, or associated channel, and establishes the network connection on the selected channel. In some examples, in block 925, the wireless device ends the channel selection process upon selection of the channel in block 920 and establishes a wireless connection on the selected connection channel. In some examples, the wireless device may establish the wireless connection with connection properties selected using the CSI. For example, the wireless device may establish the wireless connection with network traffic shaping parameters to meet traffic latency requirements for the wireless connection. For example, using the utilization information provided in the CSI, the wireless device may delay network traffic packets or schedule network traffic at times to avoid congestion on the selected connection channel. In some examples, the uses of the CSI information in blocks 910-925 allows for scan process and other process to be skipped at the wireless device and for the wireless device to select a radio channel that provides a persistent and resilient connection, thus avoiding a need to frequently switch channels.

In another example, such as when the channel quality for the at least one channel does not meet the channel requirements for the wireless device, process 900 proceeds from block 915 to block 930 where the wireless device excludes the at least one channel from the channel scans in the channel selection process. For example, when a given channel is does not meet QoS, the wireless device may skip the time and resource usage needed to scan the channel or channels and proceed to scan only the radio channel where there is no information in the CSI received from the sending device.

In some examples, in block 935, the wireless device resumes the channel scans at the wireless device. For example, as described with reference to FIG. 7, the wireless device may resume the paused scan process 761 while skipping the removed channels.

In some examples, in block 940, the wireless device selects a scanned channel with an associated channel quality that meets the channel requirements for the wireless device. For example, the wireless device may scan the remaining radio channels and determine from the scanned information on which channel the network connection should be established. Upon selection of the scanned channel, the process proceeds to block 925 to end the channel selection process and establish the wireless connection on the selected connection channel.

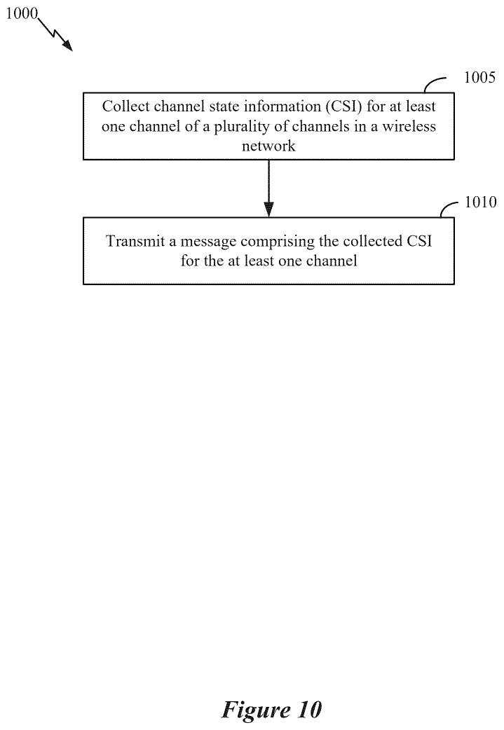

FIG. 10 shows a flowchart illustrating an example process 1000 performable by a wireless device that supports collecting and providing CSI in a wireless communication environment. The operations of the process 1000 may be implemented by a wireless device or its components as described herein. For example, the process 1000 may be performed by a wireless communication device, such as the wireless communication device 1300 described with reference to FIG. 13, operating as or within a wireless device. In some examples, the process 1000 may be performed by a wireless device such as one of the wireless devices 404, wireless devices 406 and an AP 402 described with reference to FIG. 4, wireless devices 505 and 605 described with reference to FIGS. 5 and 6 and device 705 described in relation to FIG. 7.

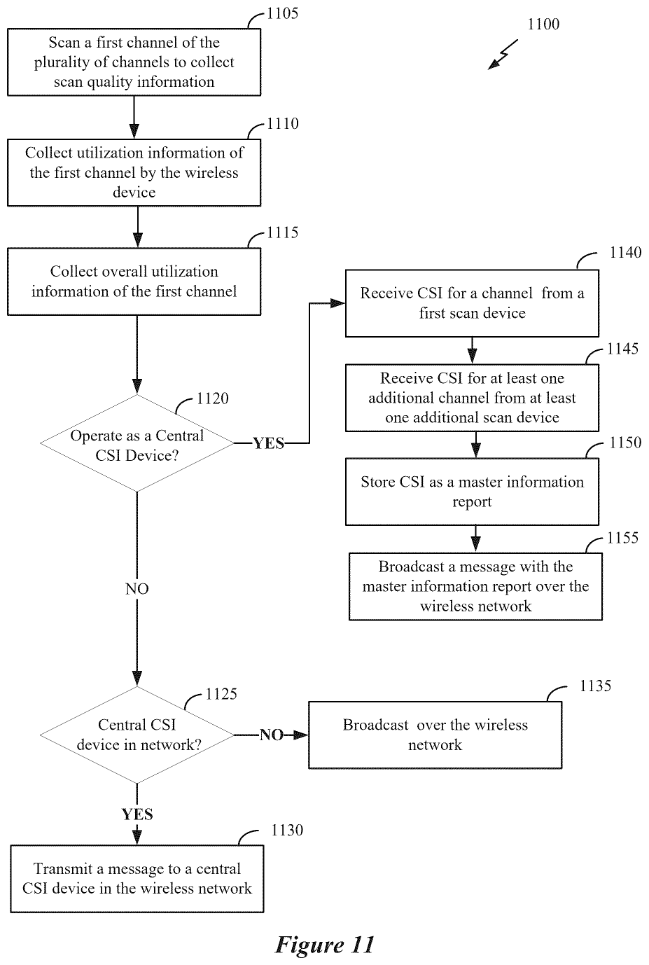

In some examples, in block 1005, the wireless device collects CSI for at least one channel of a plurality of channels in a wireless communication environment. In some examples, the wireless device may function as an autonomous CSI device or a central CSI device as described with reference to FIGS. 5 and 6 and described in more detail with reference to FIG. 11.

In some examples in block 1010, the wireless device transmits a message including the collected CSI for the at least one channel. For example, the wireless device may transmit a frame or message such as the messages 540 and 640 and messages 730.

FIG. 11 shows a flowchart illustrating an example process 1100 performable by a wireless device that supports collecting and providing CSI at central CSI devices and autonomous CSI devices in a wireless communication environment. The operations of the process 1100 may be implemented by a wireless device or its components as described herein. For example, the process 1100 may be performed by a wireless communication device, such as the wireless communication device 1300 described with reference to FIG. 13, operating as or within a wireless device. In some examples, the process 1100 may be performed by a wireless device such as one of the wireless devices 404, wireless devices 406 and an AP 402 described with reference to FIG. 4, wireless devices 505 and 605 described with reference to FIGS. 5 and 6 and device 705 described in relation to FIG. 7.

In some examples, in block 1105, the wireless device scans a first channel of the plurality of channels to collect scan quality information. For example, with reference to FIG. 5, the wireless device 505 may collect scan quality information 520 for radio channel 525a during a scan process 521 of the wireless communication environment 500. In some examples, the wireless device 505 may scan more than one or may scan all of the channels 525 and include the scan quality information for each channel 525a-525n in the CSI 510.

In some examples, in block 1110, the wireless device collects utilization information of the first channel by the wireless device. For example, the wireless device 505 also collects utilization information 530 of the home or connection channel used by the wireless device 505. For example, the wireless device 505 establishes the connection 535 on the radio channel 525a. In some examples, the utilization information 530 includes information for the local or device utilization of the connection 535 and radio channel 525a.

In some examples, in block 1115, the wireless device collects overall utilization information of the first channel. For example, the wireless device 505 may also collect overall utilization information of the 525a, including network traffic by other network connections utilizing the radio channel 525a, the presence of incumbent systems a given radio channel, other wireless devices on the radio channel 525a and metadata related to CSI. In some examples, this utilization information and other information for the radio channel may be used by a receiving wireless device to establish or update a wireless connection on the same channel to improve latency on the radio channel and perform traffic shaping to avoid traffic collision and congestion on the channel.

In some examples, in block 1120, the wireless device determines whether the wireless device is a central CSI device. In some examples, the wireless device may select to operate as a central CSI device based on a CSI collection, such as the CSI collection policy 610 at the wireless device 605 as described with reference to FIG. 6. In some examples, the CSI collection policy may be a predefined policy for the wireless device or a negotiated policy for the wireless device. In an example, where the wireless device is not operating as a central CSI device the process 1100 proceeds to block 1125.

In some examples, in block 1125, the wireless device determines whether a central CSI device is operating in the wireless communication environment. In an example, there is central CSI device in the wireless communication environment, the process 1100 proceeds to block 1130 where the wireless device transmits the message including the collected CSI to a central CSI device in the wireless communication environment. In an example, where there is no central CSI device in the wireless communication environment, the process 1100 proceeds to block 1135 where the wireless device broadcasts the message including the collected CSI over the wireless network. In another example, where the wireless device is operating as a central CSI device the process 1100 proceeds from block 1125 to block 1140.

In some examples, in block 1140, the wireless device receives CSI for a first remote channel of the plurality of channels from a first scan or collection device. In some examples, in block 1145, the wireless device receives CSI for at least one additional remote channel of the plurality of channels from at least one additional scan or collection device. For example, with reference to FIG. 6, the wireless device may receive CSI 620a-620c from the wireless devices 650a-650c.

In some examples, in block 1150, the wireless device stores the CSI for the first remote channel and the CSI for the at least one additional remote channel as a master information report at the wireless device, where the collected CSI transmitted in the message includes the master information report. In some examples, in block 1155, the wireless device broadcasts the message including the collected CSI and the master information report over the wireless network.

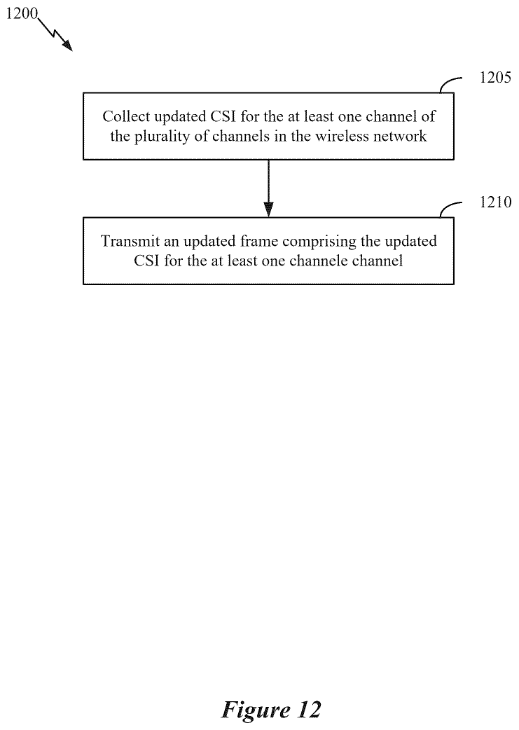

FIG. 12 shows a flowchart illustrating an example process 1200 performable by a wireless device that supports collecting and providing updated CSI in a wireless communication environment. The operations of the process 1200 may be implemented by a wireless device or its components as described herein. For example, the process 1200 may be performed by a wireless communication device, such as the wireless communication device 1300 described with reference to FIG. 13, operating as or within a wireless device. In some examples, the process 1200 may be performed by a wireless device such as one of the wireless devices 404, wireless devices 406 and an AP 402 described with reference to FIG. 4, wireless devices 505 and 605 described with reference to FIGS. 5 and 6 and device 705 described in relation to FIG. 7.

In some examples, in block 1205, the wireless device collects updated CSI for the at least one channel of the plurality of channels in the wireless communication environment. For example, with reference to FIGS. 5, 6 and 7, the wireless device may collect updated scan quality and utilization information, such as updated scan quality information 520, or updated CSI stored in the CSI MIR 615 and provide the updated CSI in additional communication or beacons, such as shown in CSI updates 722 - 738. In some examples, in block 1210, the wireless device transmits an updated message including the updated CSI for the at least one channel. For example, as shown in FIG. 7, the updated message s 730 are transmitted from the device 705 after the CSI updates.

FIG. 13 shows a block diagram of an example wireless communication device 1300 that supports collecting and using CSI to select a radio channel in a wireless network. In some examples, the wireless communication device 1300 is configured to perform the process LLL00 described with reference to FIG. 8-12. The wireless communication device 1300 may include one or more chips, SoCs, chipsets, packages, components or devices that individually or collectively constitute or include a processing system. The processing system may interface with other components of the wireless communication device 1300 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is passed to the processing system.

In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1 and any of the wireless devices 404, 406 and AP 402 described with reference to FIG. 4, wireless device 505 and wireless device 605 described with reference to FIGS. 5 and 6. In some other examples, the wireless communication device 1300 can be an AP, STA or wireless device that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes a radio component 1302, a CSI component 1304, a selection component 1306 and a policy component 1308. Portions of one or more of the components 1302, 1304, 1306 and 1308 may be implemented at least in part in hardware or firmware. For example, the radio component 1302 may be implemented at least in part by a processor or a modem. In some examples, portions of one or more of the components 1302, 1304, 1306 and 1308 may be implemented at least in part by a processor and software in the form of processor-executable code stored in a memory.

The radio component 1302 is configurable or configured to receive a message including channel state information (CSI) for at least one channel of a plurality of channels in a wireless network. The radio component 1302 is also configurable or configured to transmit a message including the local CSI for the connection channel. In some examples, the radio component 1302 is also configurable or configured to broadcast the message including a local CSI over the wireless network or transmit the message including the local CSI to a central CSI device in the wireless network. The radio component 1302 is also configurable or configured to transmit an updated message including the updated local CSI for the connection channel.

The CSI component 1304 is configurable or configured to collect local CSI for the connection channel. In some examples, the CSI component 1304 is also configurable or configured to determine from CSI received at the wireless device a channel quality for at least one channel. The CSI component 1304 is configurable or configured to collect scan quality information for the connection channel, collect utilization information of the connection channel by the wireless device and collect overall utilization information of the connection channel. In some examples, the CSI component 1304 is configurable or configured to receive CSI for at least one additional channel of a plurality of channels from at least one additional wireless device and storing the local CSI and the CSI for the at least one additional channel as a master information report at the wireless device, where the message includes the master information report. The CSI component 1304 is also configurable or configured to collect updated local CSI for a connection channel.

The selection component 1306 is configurable or configured to during a channel selection process at the wireless device, preempt a scan of the at least one channel associated with the CSI. select a connection channel for connecting to the wireless network using the CSI. The selection component 1306 is configurable or configured to pause all channel scans in the channel selection process at the wireless device and select at least one channel for connection when the channel quality for the at least one channel meets channel requirements for the wireless device, where selecting the at least one channel ends a channel selection process. The selection component 1306 is also configurable or configured to exclude the at least one channel from the channel scans in the channel selection process, resume the channel scans at the wireless device and selecting a scanned channel associated with a channel quality that meets the channel requirements for the wireless device.

The policy component 1308 is configurable or configured to select to operate as an autonomous CSI device or a central CSI device based on a CSI collection policy at the wireless device. In some examples, the CSI collection policy includes one or more of a predefined policy for the wireless device and a negotiated policy for the wireless device negotiated between the wireless device and one or more additional wireless devices in the wireless network.

Implementation examples are described in the following numbered clauses:
Clause 1. An apparatus for wireless communication at a wireless device, including: a processing system that includes processor circuitry and memory circuitry, the processing system configured to cause the wireless device to: receive a message including channel state information (CSI) for at least one channel of a plurality of channels in a wireless network; during a channel selection process at the wireless device, preempt a scan of the at least one channel associated with the CSI; and select a connection channel for connecting to the wireless network using the CSI.
Clause 2. The apparatus of clause 1, where the message indicates the CSI is collected at an autonomous CSI device in the wireless network, where the CSI includes: scan quality information for a first channel of the plurality of channels; device utilization information of the first channel by the autonomous CSI device; and overall utilization information for the first channel.
Clause 3. The apparatus of clause 1, where the message indicates the CSI is collected at a central CSI device in the wireless network, where the CSI includes a master information report including: CSI for a first channel of the plurality of channels; and CSI for at least one additional channel of the plurality of channels.
Clause 4. The apparatus of clause 1, where the CSI is encoded in a vendor-specific information element (IE) in the message.
Clause 5. The apparatus of clause 1, where the channel selection process is initiated at the wireless device by at least one of: an initial connection to the wireless network by the wireless device; and a channel quality degradation on a connected channel.
Clause 6. The apparatus of clause 1, where preempting the scan of the at least one channel associated with the CSI includes: pausing, at the wireless device, channel scans in the channel selection process; and identifying, from the CSI, a channel quality for the at least one channel; and where selecting the connection channel includes: selecting the at least one channel when the channel quality for the at least one channel meets channel requirements for the wireless device, where selecting the at least one channel ends the channel selection process.
Clause 7. The apparatus of clause 6, where selecting the connection channel further includes: when the channel quality for the at least one channel does not meet the channel requirements for the wireless device, excluding the at least one channel from the channel scans in the channel selection process; resuming the channel scans at the wireless device; and selecting a scanned channel associated with a channel quality that meets the channel requirements for the wireless device.
Clause 8. The apparatus of clause 1, where the processing system is further configured to cause the wireless device to: establish a wireless connection on the connection channel using the CSI, where the wireless connection includes connection properties selected using the CSI.
Clause 9. The apparatus of clause 8, where the processing system is further configured to cause the wireless device to: update the wireless connection on the selected connection channel using updated CSI for the selected connection channel received via an updated message.
Clause 10. The apparatus of clause 8, where the connection properties include network traffic shaping parameters to meet traffic latency requirements for the wireless connection.
Clause 11. The apparatus of clause 1, where the processing system is further configured to cause the wireless device to: collect local CSI for the connection channel; and transmit a second message including the local CSI for the connection channel.
Clause 12. The apparatus of clause 11, where the wireless device is an autonomous CSI device in the wireless network, where collecting the CSI further includes: collecting scan quality information for the connection channel; collecting device utilization information of the connection channel by the wireless device; and collecting overall utilization information of the connection channel.
Clause 13. The apparatus of clause 11, where transmitting the message includes: broadcasting the message including the local CSI over the wireless network; or transmitting the message including the local CSI to a central CSI device in the wireless network.
Clause 14. The apparatus of clause 11, where the wireless device is a central CSI device in the wireless network, where collecting the CSI further includes: receiving CSI for at least one additional channel of the plurality of channels from at least one additional wireless device; and storing the local CSI and the CSI for the at least one additional channel as a master information report at the wireless device, where the message includes the master information report.
Clause 15. The apparatus of clause 11, where the processing system is further configured to cause the wireless device to: collect updated local CSI for the connection channel; and transmit an updated message including the updated local CSI for the connection channel.
Clause 16. An apparatus for wireless communication at a wireless device, including: a processing system that includes processor circuitry and memory circuitry, the processing system configured to cause the wireless device to: collect channel state information (CSI) for at least one channel of a plurality of channels in a wireless network; and transmit a message including the collected CSI for the at least one channel.
Clause 17. The apparatus of clause 16, where the wireless device is an autonomous CSI device in the wireless network, where collecting the CSI further includes: scanning a first channel of the plurality of channels to collect scan quality information; collecting device utilization information of the first channel by the wireless device; and collecting overall utilization information of the first channel.
Clause 18. The apparatus of clause 17, where transmitting the message includes: broadcasting the message including the collected CSI over the wireless network; or transmitting the message including the collected CSI to a central CSI device in the wireless network.
Clause 19. The apparatus of clause 16, where the processing system is further configured to cause the wireless device to: operate as an autonomous CSI device or a central CSI device based on a CSI collection policy at the wireless device, where the CSI collection policy includes one or more of: a predefined policy for the wireless device; and a negotiated policy for the wireless device negotiated between the wireless device and one or more additional wireless devices in the wireless network.
Clause 20. The apparatus of clause 16, where the wireless device is a central CSI device in the wireless network, where collecting the CSI further includes: receiving CSI for a first channel of the plurality of channels from a first scan device; receiving CSI for at least one additional channel of the plurality of channels from at least one additional scan device; and storing the CSI for the first channel and the CSI for the at least one additional channel as a master information report at the wireless device, where the collected CSI transmitted in the message includes the master information report.
Clause 21. The apparatus of clause 16, where the wireless device transmits the collected CSI in a vendor-specific information element (IE) in the message.
Clause 22. The apparatus of clause 16, where the processing system is further configured to cause the wireless device to: collect updated CSI for the at least one channel of the plurality of channels in the wireless network; and transmit an updated message including the updated CSI for the at least one channel.
Clause 23. A method for wireless communication by a wireless device, including: receiving a message including channel state information (CSI) for at least one channel of a plurality of channels in a wireless network; during a channel selection process at the wireless device, preempting a scan of the at least one channel associated with the CSI; and selecting a connection channel for connecting to the wireless network using the CSI.
Clause 24. The method of clause 23, where the message indicates the CSI is collected at an autonomous CSI device in the wireless network, where the CSI includes: scan quality information for a first channel of the plurality of channels; device utilization information of the first channel by the autonomous CSI device; and overall utilization information for the first channel.
Clause 25. The method of clause 23, where the message indicates the CSI is collected at a central CSI device in the wireless network, where the CSI includes a master information report including: CSI for a first channel of the plurality of channels; and CSI for at least one additional channel of the plurality of channels.
Clause 26. The method of clause 23, where preempting the scan of the at least one channel associated with the CSI includes: pausing, at the wireless device, channel scans in the channel selection process; and identifying, from the CSI, a channel quality for the at least one channel; and where selecting the connection channel includes: selecting the at least one channel when the channel quality for the at least one channel meets channel requirements for the wireless device, where selecting the at least one channel ends the channel selection process.
Clause 27. A method for wireless communication by a wireless device, including: collecting channel state information (CSI) for at least one channel of a plurality of channels in a wireless network; and transmitting a message including the collected CSI for the at least one channel.
Clause 28. The method of clause 27, where the wireless device is an autonomous CSI device in the wireless network, where collecting the CSI further includes: scanning a first channel of the plurality of channels to collect scan quality information; collecting device utilization information of the first channel by the wireless device; and collecting overall utilization information of the first channel.
Clause 29. The method of clause 27, further including: operating as an autonomous CSI device or a central CSI device based on a CSI collection policy at the wireless device, where the CSI collection policy includes one or more of: a predefined policy for the wireless device; and a negotiated policy for the wireless device negotiated between the wireless device and one or more additional wireless devices in the wireless network.
Clause 30. The method of clause 27, where the wireless device is a central CSI device in the wireless network, where collecting the CSI further includes: receiving CSI for a first channel of the plurality of channels from a first scan device; receiving CSI for at least one additional channel of the plurality of channels from at least one additional scan device; and storing the CSI for the first channel and the CSI for the at least one additional channel as a master information report at the wireless device, where the collected CSI transmitted in the message includes the master information report.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a wireless device, comprising:
a processing system that includes processor circuitry and memory circuitry, the processing system configured to cause the wireless device to:
receive a message comprising channel state information (CSI) for at least one channel of a plurality of channels in a wireless network;
during a channel selection process at the wireless device, preempt a scan of the at least one channel associated with the CSI; and
select a connection channel for connecting to the wireless network using the CSI.

2. The apparatus of claim 1, wherein the message indicates the CSI is collected at an autonomous CSI device in the wireless network, wherein the CSI comprises:
scan quality information for a first channel of the plurality of channels;
device utilization information of the first channel by the autonomous CSI device; and
overall utilization information for the first channel.

3. The apparatus of claim 1, wherein the message indicates the CSI is collected at a central CSI device in the wireless network, wherein the CSI comprises a master information report comprising:
CSI for a first channel of the plurality of channels; and
CSI for at least one additional channel of the plurality of channels.

4. The apparatus of claim 1, wherein the CSI is encoded in a vendor-specific information element (IE) in the message.

5. The apparatus of claim 1, wherein the channel selection process is initiated at the wireless device by at least one of:
an initial connection to the wireless network by the wireless device; and
a channel quality degradation on a connected channel.

6. The apparatus of claim 1, wherein preempting the scan of the at least one channel associated with the CSI comprises:
pausing, at the wireless device, channel scans in the channel selection process; and
identifying, from the CSI, a channel quality for the at least one channel; and wherein selecting the connection channel comprises:
selecting the at least one channel when the channel quality for the at least one channel meets channel requirements for the wireless device, wherein selecting the at least one channel ends the channel selection process.

7. The apparatus of claim 6, wherein selecting the connection channel further comprises:
when the channel quality for the at least one channel does not meet the channel requirements for the wireless device, excluding the at least one channel from the channel scans in the channel selection process;
resuming the channel scans at the wireless device; and
selecting a scanned channel associated with a channel quality that meets the channel requirements for the wireless device.

8. The apparatus of claim 1, wherein the processing system is further configured to cause the wireless device to:
establish a wireless connection on the connection channel using the CSI, wherein the wireless connection comprises connection properties selected using the CSI.

9. The apparatus of claim 8, wherein the processing system is further configured to cause the wireless device to:
update the wireless connection on the selected connection channel using updated CSI for the selected connection channel received via an updated message.

10. The apparatus of claim 8, wherein the connection properties comprise network traffic shaping parameters to meet traffic latency requirements for the wireless connection.

11. The apparatus of claim 1, wherein the processing system is further configured to cause the wireless device to:
collect local CSI for the connection channel; and
transmit a second message comprising the local CSI for the connection channel.

12. The apparatus of claim 11, wherein the wireless device is an autonomous CSI device in the wireless network, wherein collecting the CSI further comprises:
collecting scan quality information for the connection channel;
collecting device utilization information of the connection channel by the wireless device; and
collecting overall utilization information of the connection channel.

13. The apparatus of claim 11, wherein transmitting the message comprises:
broadcasting the message comprising the local CSI over the wireless network; or
transmitting the message comprising the local CSI to a central CSI device in the wireless network.

14. The apparatus of claim 11, wherein the wireless device is a central CSI device in the wireless network, wherein collecting the CSI further comprises:
receiving CSI for at least one additional channel of the plurality of channels from at least one additional wireless device; and
storing the local CSI and the CSI for the at least one additional channel as a master information report at the wireless device, wherein the message comprises the master information report.

15. The apparatus of claim 11, wherein the processing system is further configured to cause the wireless device to:
collect updated local CSI for the connection channel; and
transmit an updated message comprising the updated local CSI for the connection channel.

16. An apparatus for wireless communication at a wireless device, comprising:
a processing system that includes processor circuitry and memory circuitry, the processing system configured to cause the wireless device to:
collect channel state information (CSI) for at least one channel of a plurality of channels in a wireless network; and
transmit a message comprising the collected CSI for the at least one channel.

17. The apparatus of claim 16, wherein the wireless device is an autonomous CSI device in the wireless network, wherein collecting the CSI further comprises:
scanning a first channel of the plurality of channels to collect scan quality information;
collecting device utilization information of the first channel by the wireless device; and
collecting overall utilization information of the first channel.

18. The apparatus of claim 17, wherein transmitting the message comprises:
broadcasting the message comprising the collected CSI over the wireless network; or
transmitting the message comprising the collected CSI to a central CSI device in the wireless network.

19. The apparatus of claim 16, wherein the processing system is further configured to cause the wireless device to:
operate as an autonomous CSI device or a central CSI device based on a CSI collection policy at the wireless device, wherein the CSI collection policy comprises one or more of:
a predefined policy for the wireless device; and
a negotiated policy for the wireless device negotiated between the wireless device and one or more additional wireless devices in the wireless network.

20. The apparatus of claim 16, wherein the wireless device is a central CSI device in the wireless network, wherein collecting the CSI further comprises:
receiving CSI for a first channel of the plurality of channels from a first scan device;
receiving CSI for at least one additional channel of the plurality of channels from at least one additional scan device; and
storing the CSI for the first channel and the CSI for the at least one additional channel as a master information report at the wireless device, wherein the collected CSI transmitted in the message comprises the master information report.

21. The apparatus of claim 16, wherein the wireless device transmits the collected CSI in a vendor-specific information element (IE) in the message.

22. The apparatus of claim 16, wherein the processing system is further configured to cause the wireless device to:
collect updated CSI for the at least one channel of the plurality of channels in the wireless network; and
transmit an updated message comprising the updated CSI for the at least one channel.

23. A method for wireless communication by a wireless device, comprising:
receiving a message comprising channel state information (CSI) for at least one channel of a plurality of channels in a wireless network;
during a channel selection process at the wireless device, preempting a scan of the at least one channel associated with the CSI; and
selecting a connection channel for connecting to the wireless network using the CSI.

24. The method of claim 23, wherein the message indicates the CSI is collected at an autonomous CSI device in the wireless network, wherein the CSI comprises:
scan quality information for a first channel of the plurality of channels;
device utilization information of the first channel by the autonomous CSI device; and
overall utilization information for the first channel.

25. The method of claim 23, wherein the message indicates the CSI is collected at a central CSI device in the wireless network, wherein the CSI comprises a master information report comprising:
CSI for a first channel of the plurality of channels; and
CSI for at least one additional channel of the plurality of channels.

26. The method of claim 23, wherein preempting the scan of the at least one channel associated with the CSI comprises:
pausing, at the wireless device, channel scans in the channel selection process; and
identifying, from the CSI, a channel quality for the at least one channel; and wherein selecting the connection channel comprises:
selecting the at least one channel when the channel quality for the at least one channel meets channel requirements for the wireless device, wherein selecting the at least one channel ends the channel selection process.

27. A method for wireless communication by a wireless device, comprising:
collecting channel state information (CSI) for at least one channel of a plurality of channels in a wireless network; and
transmitting a message comprising the collected CSI for the at least one channel.

28. The method of claim 27, wherein the wireless device is an autonomous CSI device in the wireless network, wherein collecting the CSI further comprises:
scanning a first channel of the plurality of channels to collect scan quality information;
collecting device utilization information of the first channel by the wireless device; and
collecting overall utilization information of the first channel.

29. The method of claim 27, further comprising:
operating as an autonomous CSI device or a central CSI device based on a CSI collection policy at the wireless device, wherein the CSI collection policy comprises one or more of:
a predefined policy for the wireless device; and
a negotiated policy for the wireless device negotiated between the wireless device and one or more additional wireless devices in the wireless network.

30. The method of claim 27, wherein the wireless device is a central CSI device in the wireless network, wherein collecting the CSI further comprises:
receiving CSI for a first channel of the plurality of channels from a first scan device;
receiving CSI for at least one additional channel of the plurality of channels from at least one additional scan device; and
storing the CSI for the first channel and the CSI for the at least one additional channel as a master information report at the wireless device, wherein the collected CSI transmitted in the message comprises the master information report.
